(19) United States
(12) Patent Application Publication
(10) Pub. No.: US 2011/0138516 A1
(43) Pub. Date: Jun. 16, 2011

(54) HIGHLY FUNCTIONAL POLYETHYLENE FIBER, WOVEN/KNITTED TEXTILE COMPRISING SAME, AND GLOVE THEREOF

(75) Inventors: Yasunori Fukushima, Shiga (JP); Syoji Oda, Shiga (JP); Minoru Masuda, Fukui (JP)

(73) Assignee: Toyo Boseki Kabushiki Kaisha, Osaka (JP)

(21) Appl. No.: 13/059,822

(22) PCT Filed: Aug. 20, 2009
(86) PCT No.: PCT/JP2009/064592

§ 371 Date: Feb. 18, 2011

(30) Foreign Application Priority Data
Aug. 20, 2008 (JP) 2008211801

(51) Int. Cl. A41D 19/015; A41D 13/00; D02G 3/36; C08F 110/02

(52) U.S. Cl. 2/159; 428/221; 57/225; 526/352

(57) ABSTRACT

The present invention provides a highly functional polyethylene fiber which has excellent heat-retaining property and cut resistance, and is further excellent in productivity and process passability in subsequent processes, a covered elastic yarn, woven/knitted textiles, and gloves using the highly functional polyethylene fiber. A polyethylene fiber of the present invention comprises a polyethylene, wherein a repeating unit of the polyethylene is substantially ethylene, and the polyethylene fiber has a weight average molecular weight (Mw) of 50,000 to 300,000, a ratio (Mw/Mn) of the weight average molecular weight to a number average molecular weight (Mn) of less than or equal to 4.0, and a gel fraction of 100 ppm or more and 10,000 ppm or less, or a zero shear viscosity in a molten state at 190° C. of ranging from 8,000 (Pa·s) to 300,000 (Pa·s).

### TECHNICAL FIELD

The present invention relates to a polyethylene fiber which is high in productivity, is excellent in heat retaining property and abrasion resistance, and is further excellent in process passability in subsequent processes, and to textiles and cut-resistant gloves using the polyethylene fiber.

### BACKGROUND ART

Conventionally, cotton which is a natural fiber, and an organic fiber are used as a cut-resistant raw material, and gloves into which such a fiber and the like are knitted are widespread in fields in which cut resistance is required.

Knitted products and woven products have been suggested which are produced by using spun yarns of a high strength fiber such as an aramid fiber so as to provide cut resistance. However, the knitted products and woven products have been unsatisfactory from the standpoint of fiber detachment and durability. On the other hand, another method in which cut resistance is enhanced by using a metal fiber together with an organic fiber or a natural fiber is attempted. However, the use of a metal fiber causes texture to become hard, thereby deteriorating flexibility.

As inventions for solving the aforementioned problems, textiles and gloves in which a polyethylene fiber having a high modulus is used are suggested (for example, see Patent Literature 1 and 2). However, the modulus of the fiber is excessively high, so that an index value obtained in a cut resistance measurement using a coup tester is 3.8 at best as well as the texture becomes hard. Further, the cut resistance is improved by increasing a strength and a modulus, so that thermal conductivity is also increased. Therefore, when fresh foods are handled by, for example, meatpacking company staffs, their hands are cooled, or, on the contrary, raw materials such as meat are thawed and softened due to heat of their hands, so that, for example, the raw material cannot be cut as intended, thereby deteriorating the workability. Further, since a polyethylene resin having a high molecular weight is used, a drawing speed cannot be increased, which does not allow enhancement of productivity. Further, spinning instability such as draw resonance is likely to occur, so that unevenness of yarn is likely to occur, which may cause yarn breakage in subsequent processes.

### CITATION LIST

### Patent Literature

PTL 1: Japanese published unexamined application No. 2002-180324
PTL 2: Japanese published unexamined application No. 2004-19050

### SUMMARY OF INVENTION

### Problems to be Solved by the Invention

The present invention is made in order to solve the aforementioned problems, and an object of the present invention is to provide a highly functional polyethylene fiber which has excellent heat-retaining property and cut resistance, and is further excellent in productivity and process passability in subsequent processes, and to provide a covered elastic yarn, woven/knitted textiles, and gloves using the highly functional polyethylene fiber.

### Means for Solving the Problem

The present invention includes aspects as described below;

(1) A polyethylene fiber comprises a polyethylene, wherein a repeating unit of the polyethylene is substantially ethylene, and the polyethylene fiber has, when the polyethylene is in a fibrous state, a weight average molecular weight (Mw) ranging from 50,000 to 300,000, and has a ratio (Mw/Mn) of the weight average molecular weight to a number average molecular weight (Mn) which is less than or equal to 4.0, wherein a gel fraction of the fiber ranges from 100 ppm to 10,000 ppm.

(2) A polyethylene fiber comprising a polyethylene, wherein a repeating unit of the polyethylene is substantially ethylene, and the polyethylene fiber has, when the polyethylene is in a fibrous state, a weight average molecular weight (Mw) ranging from 50,000 to 300,000, and has a ratio (Mw/Mn) of the weight average molecular weight to a number average molecular weight (Mn) which is less than or equal to 4.0, wherein a zero shear viscosity of the fiber in a molten state at 190° C. ranges from 8,000 (Pa·s) to 300,000 (Pa·s).

The polyethylene fiber, a variation represented as a CV % in a fineness among single yarns is preferably less than 5%. Further, as for the polyethylene fiber of the present invention, an unevenness U % of a fineness in a yarn longitudinal direction is preferably less than 30%, furthermore, a thermal conductivity in a fiber axis direction of preferably ranges from 6 W/mK to 50 W/mK at a measurement temperature of 300K. Additionally, a rate of change of the thermal conductivity in the fiber axis direction of the polyethylene fiber is preferably greater than or equal to 6 W/mK·K when a measurement temperature is varied from 100K to 300K.

The present invention includes a covered elastic yarn comprising an elastic fiber and the polyethylene fiber covering the elastic fiber; a protective textile comprising, as an at least a portion of the protective textile, the polyethylene fiber and/or the covered elastic yarn, wherein the protective textile has an index value measured by a coup tester is greater than or equal to 6. Further, a cut resistant glove comprises the protective textile, which is one of a preferable embodiment of the present invention.

### Advantageous Effects of the Invention

The highly functional polyethylene fiber according to the present invention has high heat-retaining property and cut resistance, and therefore it is advantageous in that, for example, workability is enhanced particularly when the highly functional polyethylene fiber is used for gloves for meatpacking company staff, and it is also economically advantageous in that productivity and process passability in subsequent processes of the polyethylene fiber are enhanced.

### DESCRIPTION OF EMBODIMENTS

Hereinafter, the present invention will be described in detail.

A highly functional polyethylene fiber according to the present invention preferably has a gel fraction which ranges from 100 ppm to 10,000 ppm. The inventors of the present invention have found that, when the gel fraction is within the range described above, excellent cut resistance can be obtained without increasing a strength and a modulus. Specifically, since, in a high strength polyethylene fiber, molecules are highly oriented and crystallized in a fiber axis direction, molecular entanglements are extremely reduced. Further, the high strength polyethylene fiber does not have a hydrogen bonding group, so that molecular interaction is extremely weak. Therefore, the polyethylene fiber is susceptible to an external force applied in a direction orthogonal to the fiber axis, and separation between molecules is likely to occur. However, the highly functional polyethylene fiber of the present invention has a gel fraction greater than or equal to 100 ppm, and therefore has an enhanced resistance to an external force applied in the direction orthogonal to the fiber axis. Although the reason why the cut resistance is enhanced due to the gel being contained in the fiber is not clear, the inventors of the present invention consider that, when a hard component such as a gel is appropriately contained in the fiber, a resistance to an external force can be greatly enhanced. Thus, although a strength and a modulus tend to be reduced, excellent cut resistance can be obtained.

On the other hand, when the gel fraction is greater than 10,000 ppm, the strength of the fiber becomes insufficient. The gel fraction more preferably ranges from 400 ppm to 5,000 ppm, and even more preferably ranges from 1,000 ppm to 4,000 ppm.

In the present embodiment, the gel fraction represents a value obtained as follows. That is, a sample of the polyethylene fiber is put in a filter mesh formed in a cylindrical shape, and only a non-gel portion of the polyethylene, which has not gelled in hot xylene, is then extracted and removed, and a mass (W3) of the filter from which the non-gel portion of the polyethylene has been extracted is measured, and the gel fraction is calculated, based on the following equation, by using a mass (W2) of the filter which contains the sample having not been subjected to the extraction, and a mass (W1) of the filter only.

Gel fraction(ppm)=10⁶×(W3−W1)/(W2−W1)

The gel fraction represents a content of a polyethylene component which is insoluble in a solvent. Specifically, the gel fraction represents a content of components such as molecular chains which are highly entangled with each other, aggregates, and crosslinked components. Namely, the highly functional polyethylene fiber of the present invention contains components in which molecular aggregation and bonding are high.

A method for adjusting the gel fraction so as to be greater than or equal to 100 ppm is not limited to any specific method, and, for example, generation of a crosslinked component may be utilized. A method for generating a component insoluble in a solvent through crosslinking is preferably used since the gel fraction can be easily controlled.

As a method for crosslinking polyolefins, a method based on a radical reaction process using a peroxide radical formation material or based on electron beam irradiation is used. Namely, in the present invention, as a method for crosslinking polyolefins, a method in which a peroxide radical formation material or electron beam irradiation is used to generate radicals in polyolefin chains, and the resultant is heated to successively crosslink the polyolefins, is used instead of a method for performing crosslinking by using functional groups.

As a method for generating crosslinked components in the polyethylene, for example, a method may be used in which a crosslinking agent such as a peroxide or a silane compound is mixed, as the radical formation component, with a polyethylene resin, and the resultant is heat-treated, to introduce a crosslinked structure in the polyethylene. At this time, a crosslinking auxiliary may be used.

Examples of the crosslinking agent include: peroxides such as dicumyl peroxide, 1,3-bis-(t-butylperoxy-isopropyl)-benzene, lauroyl peroxide, di-t-butylperoxy isophthalate, 4,4-di-(t-butylperoxy)valeric acid-butyl ester, 1,1-di-t-butylperoxy-3,3,5-trimethylcyclohexane, 2,5-dimethyl-2,5-di(t-butylperoxy)hexane, 2,5-dimethyl-2,5-di(t-butylperoxy)hexyne, benzoyl peroxide, α,α-di(t-butylperoxy isopropyl)benzene, t-butyl peroxy ketone, and t-butyl peroxy benzoate; and silane compounds such as vinyl trimethoxysilane, vinyl triethoxy silane, vinyl tributoxy silane, allyltrimethoxysilane, vinyl methyl dimethoxy silane, and vinyl tris(β-methoxyethoxy)silane.

Further, examples of the crosslinking auxiliary include divinylbenzene, trimethylol propane trimethacrylate, 1,6-hexanediol methacrylate, 1,9-nonanediol dimethacrylate, 1,10-decanediol dimethacrylate, trimellitic acid triallyl ester, triallyl isocyanate, neopentyl glycol dimethacrylate, 1,2,4-benzenetricarboxylic acid triallyl ester, tricyclodecane dimethacrylate, and polyethylene glycol diacrylate.

A content of the crosslinking agent is preferably less than or equal to 8,000 ppm, and the content of the crosslinking agent may be determined depending on a kind of the crosslinking agent such that the gel fraction of the fiber ranges from 100 ppm to 10,000 ppm. However, it is not preferable that the content of the crosslinking agent is greater than 8,000 ppm in the polyethylene, because the crosslinking agent acts as impurities, and therefore yarn breakage occurs during spinning and drawing. The content of the crosslinking agent is more preferably 4,000 ppm or less with respect to the amount of the polyethylene resin, and is even more preferably 2,000 ppm or less, and is in particular preferably 1,000 ppm or less.

A reaction for introducing the crosslinked structure into the polyethylene is not limited to any specific one. Any conventionally known method may be used. For example, a method may be used in which the polyethylene resin is mixed with the crosslinking agent described above, or with the crosslinking agent and the crosslinking auxiliary described above, in an extruder, to heat the mixture.

The highly functional polyethylene fiber of the present invention is formed of a polyethylene which has, when the polyethylene is in a fibrous state, a weight average molecular weight (Mw) which ranges from 50,000 to 300,000, preferably ranges from 60,000 to 250,000, and more preferably ranges from 70,000 to 200,000, and has a ratio (Mw/Mn) of the weight average molecular weight (Mw) to a number average molecular weight (Mn), which is less than or equal to 4.0, and is preferably less than or equal to 3.7, and is more preferably less than or equal to 3.3.

In the ranges described above, high speed fiber drawing may be carried out. However, in the polyethylene fiber having the Mw, and the Mw/Mn in the ranges described above, unevenness of yarn is likely to occur. The inventors of the present invention have recognized that the unevenness of yarn is caused by spinning instability which occurs due to draw resonance, and have found that the gel fraction which is set as described above can ameliorate the unevenness of yarn. Although the reason therefor is not clear, the yarn tension in spinning can be increased by an appropriate amount of gel being contained in the fiber. It is considered that this may reduce the unevenness of yarn in spinning.

Further, the lower limit of the Mw/Mn ratio is preferably 1.2, and is more preferably 1.5, and is in particular preferably 2.0 from the standpoint of controllability in manufacturing.

Moreover, the highly functional polyethylene fiber of the present invention is formed of a polyethylene which has, when the polyethylene is in a fibrous state, a weight average molecular weight (Mw) which ranges from 50,000 to 300,000, and has a ratio (Mw/Mn) of the weight average molecular weight (Mw) to the number average molecular weight (Mn) which is less than or equal to 4.0. Further, a zero shear viscosity of the highly functional polyethylene fiber of the present invention in a molten state at 190° C. ranges from 8,000 to 300,000 (Pa·s), and preferably ranges from 9,000 to 250,000 (Pa·s), and even more preferably ranges from 10,000 to 200,000 (Pa·s).

When the Mw and the Mw/Mn are as described above, and the zero shear viscosity is 8,000 (Pa·s) or more, it means that a component, such as a crosslinked component and an aggregate, exerting an elastic behavior is contained. Thus, as described above, excellent cut resistance is provided to the polyethylene fiber, and unevenness of yarn can be reduced at a high drawing speed. Namely, when the zero shear viscosity is less than 8,000 (Pa·s), the tension at the drawing is extremely reduced, and susceptibility to disturbance is increased, thereby resulting in unevenness in fineness and unevenness in structure in the fiber longitudinal direction being likely to occur, which is unfavorable.

On the other hand, the polyethylene in a fibrous state has a weight average molecular weight (Mw) which is greater than 300,000, for example, melt fracture may be caused during spinning, so that the unevenness in fineness tends to be unfavorably increased in the fiber longitudinal direction.

In the highly functional polyethylene fiber of the present invention, a variation, represented as CV(%), in fineness among single yarns is preferably less than 5%. This is because, when the CV(%) is within the range as described above, troubles, such as yarn breakage at yarn release, which may occur in subsequent process steps before final products are obtained, can be reduced. The variation CV(%) in fineness among single yarns is more preferably less than 4%, and is even more preferably less than 3%. The lower limit of the variation CV(%) in fineness among single yarns need not be specified. However, it is technically difficult to reduce the variation so as to be less than 0.01%. Further, even if the variation is reduced so as to be less than 0.01%, influence on process passability in subsequent processes is not greatly changed.

In the highly functional polyethylene fiber of the present invention, an unevenness U(%) in fineness in the yarn longitudinal direction is preferably less than 30%. This is because, when the U(%) is within the range described above, troubles, such as yarn breakage at yarn release, which may occur in subsequent process steps before final products are obtained, can be reduced. The U(%) is more preferably less than 15%, and is even more preferably less than 5%. The lower limit of the U(%) need not be specified. However, it is technically difficult to reduce the U(%) so as to be less than 0.1%. Further, even if the U(%) is reduced so as to be less than 0.1%, an influence on process passability in subsequent processes is not greatly changed.

In the highly functional polyethylene fiber of the present invention, a thermal conductivity in the fiber axis direction preferably ranges from 6 W/mK to 50 W/mK at a measurement temperature of 300K. This is because products, such as gloves, having an enhanced heat-retaining property can be obtained. The thermal conductivity in the fiber axis direction more preferably ranges from 10 W/mK to 45 W/mK, and even more preferably ranges from 15 W/mK to 35 W/mK.

In the highly functional polyethylene fiber of the present invention, a rate of change in thermal conductivity in the fiber axis direction is preferably greater than or equal to 6 W/mK·K when the measurement temperature varies from 100K to 300K. Specifically, this is because, when the thermal conductivity is reduced as the temperature decreases to cause a severe environment, the polyethylene fiber can be used even at an extremely low temperature as well as at room temperature.

In the highly functional polyethylene fiber of the present invention, an average tensile strength is preferably greater than or equal to 8 cN/dtex. This is because the usage of the polyethylene fiber having such a strength can be expanded so as to cover a usage which cannot be realized by general-purpose fibers obtained by a melt spinning method. The average tensile strength is more preferably greater than or equal to 10 cN/dtex, and is even more preferably greater than or equal to 12 cN/dtex. Although the upper limit of the strength need not be specified, it is difficult to obtain, by using a melt spinning method, a fiber having an average tensile strength which is greater than or equal to 50 cN/dtex, in terms of a technique and industrial manufacturing. Further, even the highly functional polyethylene fiber of the present invention having an average tensile strength which is less than 15 cN/dtex exerts an enhanced cut resistance.

In the highly functional polyethylene fiber of the present invention, a modulus preferably ranges from 400 cN/dtex to 750 cN/dtex. Conventionally, a higher modulus is considered to be more preferable. However, the inventors of the present invention have found that the modulus should be neither excessively low nor excessively high, in order to be resistant to cutting by a knife and the like. In the range described above, a numerical value which is greater than or equal to 5 is likely to be obtained in the cut resistance evaluation in which a coup tester is used.

The reason therefor may be as follows. When the modulus is excessively high, energy is received at a portion touched by a sharp object such as a knife at the moment of the portion being touched by the sharp object. However, when the modulus is within a certain range, the orientation of the molecular chains have some allowance, and the energy is absorbed in the entirety of the range including the portion touched by the sharp object and the vicinity thereof. Further, when the modulus is excessively low, the orientation of the molecular chains is insufficient, and the molecular chains are likely to be separated at the micro level. The modulus as described above more preferably ranges from 450 cN/dtex to 720 cN/dtex, and even more preferably ranges from 500 cN/dtex to 700 cN/dtex.

Hereinafter, a favorable manufacturing method for obtaining the highly functional polyethylene fiber of the present invention by using a melt spinning method will be described.

Specifically, pellets of a polyethylene resin having a weight average molecular weight (Mw) ranging from 50,000 to 300,000, and having a ratio (Mw/Mn) of the weight average molecular weight (Mw) to a number average molecular weight (Mn) which is less than or equal to 4.0, is mixed with powdered radical formation material (in the present invention, it may be referred to as a crosslinking agent), and the mixture is kneaded by using a melt-extruder. A twin-screw extruder is preferably used as the melt-extruder.

Further, an amount of a crosslinking agent to be blended in the polyethylene resin is adjusted so as to be less than or equal to 5% by mass with respect to the amount of the polyethylene resin, depending on a kind of the crosslinking agent, such that the gel fraction of the fiber ranges from 100 ppm to 10,000 ppm, or the zero shear viscosity of the fiber in the molten state at 190° C. ranges from 8,000 to 300,000 (Pa·s).

The melt-extruded polyethylene resin composition is spun into a yarn in a uniform amount through a spinneret by using a gear pump. The crosslinking reaction takes place in heat treatment which is performed from melting and kneading to discharging through the spinneret. A spinning temperature is preferably higher than or equal to “a melting point of the polyethylene+90° C.”, and is lower than “the melting point of the polyethylene+200° C.”. Further, throughput is preferably adjusted such that a heating time period (residence time) from charging of the above-described polyethylene resin composition into the melt-extruder to discharging thereof through the spinneret is less than 60 minutes.

Subsequently, the yarn is cooled with cold air, and is taken up at a predetermined speed. Further, it is preferable that (a) a one-step drawing is performed in which the undrawn yarn having been taken up is drawn at a temperature which is higher than or equal to a crystal dispersion temperature of the fiber and is not higher than the melting point of the fiber, for example, at 90° C. or a higher temperature. Alternatively, it is preferable that (b) a two-step drawing is performed in which the undrawn yarn having been taken up is drawn at a temperature which is lower than or equal to 70° C., and the obtained yarn is then drawn at a temperature which is higher than the drawing temperature described above, and is lower than or equal to the melting point, specifically, at a temperature which is higher than or equal to 90° C. and is not higher than the melting point. At this time, the fiber may be subjected to three or more step drawing.

A drawing speed and a draw ratio may be adjusted as necessary such that desired physical property values can be obtained (for example, the average tensile strength is greater than or equal to 8 cN/dtex, or the modulus ranges from 400 cN/dtex to 750 cN/dtex). When the yarn is drawn so as not to be broken, on the conditions that a drawing stress is increased so as to obtain a high molecular orientation (the drawing temperature: low (↓), the draw ratio: high (↑), and the drawing speed: high (↑)), the physical property values described above tend to be enhanced in general. Further, also when a draft ratio (spinning speed (take-up speed)/throughput) of the undrawn yarn is set to be high, a high molecular orientation can be favorably obtained. The setting of the conditions as described above is a matter of design variation, which does not require excessive experiments, for a person of ordinary skill in the art.

The highly functional polyethylene fiber of the present invention may cover an elastic yarn to form a covered elastic yarn. The highly functional polyethylene fiber of the present invention is excellent in cut resistance and heat retaining property. Therefore, the polyethylene fiber in a form of a thin fabric can meet the needs of markets. However, when an elastic yarn is used to enhance a stretching property and a fitting property, a fabric which provides excellent wearing feeling and comfortableness can be realized.

Although the usages of the highly functional polyethylene fiber of the present invention are various, the polyethylene fiber is preferably used for protective woven or knitted textiles which need to have an index value of a coup tester which is greater than or equal to 6, thereby exhibiting the features described above.

The final usage of the highly functional polyethylene fiber of the present invention is not specified. However, when the polyethylene fiber is used for gloves requiring cut resistance, gloves can be realized which have both the cut resistance and the heat-retaining property, and are further lightweight.

### EXAMPLES

Hereinafter, the present invention will be specifically described by means of examples. However, the present invention is not limited to examples described below. Measurements and evaluations in examples were conducted as follows.

(A) Tensile Strength and Modulus.

A strength and a modulus were calculated as follows.

That is, stress-strain curve was obtained, under the condition that a length of a sample was 200 mm, and an elongation rate was 100%/min., an atmospheric temperature was 25° C., and a relative humidity was 65%; by using “TENSILON Universal Material Testing Instrument” manufactured by ORIENTEC Co., LTD., and a stress at the breaking point on the curve obtained was calculated as a tensile strength (cN/dtex), and a modulus (cN/dtex) was calculated from the tangent line providing a maximum gradient on the curve in the vicinity of the originating point. The measurement was conducted ten times, and an average of values obtained in the ten measurements was used for each of the tensile strength and the modulus.

(B) Thermal Conductivity.

A thermal conductivity was measured, by using a system including a temperature control device with a helium refrigerator, in a steady-state heat flow method. A length of a sample was about 25 mm, and a fiber bundle was obtained by about 5000 monofilaments being aligned and collected into a bundle. The ends of the fiber were fixed bundle by using “STYCAST GT” (an adhesive manufactured by Grace Japan Co., Ltd.), to set the fiber on a sample stage. For measuring temperatures, an Au-chromel thermocouple was used. As a heater, 1 kΩ resistance was used, and the heater was adhered to an end of the fiber bundle by using a varnish. The two levels of measurement temperatures, that is, 300 K and 100 K, were used. The measurement was conducted in a vacuum state of 10⁻⁵ torr in order to maintain thermal insulation. The measurement was started after the vacuum state of 10⁻⁵ torr had been maintained for 24 hours, in order to dry the sample.

When a cross-sectional area of the fiber bundle is represented as S, a distance between the thermocouples is represented as L, an amount of heat applied by the heater is represented as Q, and a difference in temperature between the thermocouples is represented as αT, a thermal conductivity G to be obtained is calculated as G(mW/cmK)=(Q/αT)·(L/S). The measurement method is described in detail in the following documents.

H. Fujishiro, M. Ikebe, T. Kashima. A. Yamanaka, Jpn. J. Appl. Phys., 36, 5633 (1997)
H. Fujishiro, M. Ikebe, T. Kashima. A. Yamanaka, Jpn. J. Appl. Phys., 37, 1994 (1998)

(C) Cut Resistance Measurement.

As an evaluation method, a method using a coup tester (cut tester manufactured by SODMAT) was used. An aluminum foil was provided on a sample stage of the tester, and a sample was put on the aluminum foil. Next, a circular blade provided on the tester was caused to travel on the sample while the circular blade was being simultaneously rotated in a direction opposite to the traveling direction. When the sample had been cut, the circular blade and the aluminum foil contacted each other, so that an electric current flows, and it was determined that the cut resistance test had been ended. While the circular blade was operating, a counter mounted to the tester counts numerical values in accordance with the number of revolutions of the circular blade, and the numerical values were recorded.

In the test, a plain-woven cotton fabric having a weight per unit area of about 200 g/m² was used as a blank, and a cut level of the test sample (gloves) was evaluated. The test was started with the blank, and the test of the blank and the test of the test sample were alternately performed, and the test sample was tested five times, and the test was ended with the sixth test of the blank, thereby completing one set of tests. Five sets of the tests were performed, and an average Index value obtained from the five sets of the tests was employed as a substitute evaluation value for the cut resistance. It is considered that the higher the Index value is, the more excellent the cut resistance is.

The evaluation value obtained as described above was referred to as an Index, and the Index was calculated by using the following equation.

A=(a counted value for the cotton fabric obtained before the sample test+a counted value for the cotton fabric obtained after the sample test)/2

Index=(a counted value for the sample+A)/A

A cutter used for this evaluation was an L-type rotary cutter, manufactured by OLFA CORPORATION, having φ45 mm. The material thereof was an SKS-7 tungsten steel, and a thickness of the blade was 0.3 mm. An applied load in the test was 3.14 N (320 gf). Thus, an evaluation was made.

(D) Weight average molecular weight Mw, number average molecular weight Mn, and Mw/Mn.

The weight average molecular weight Mw, the number average molecular weight Mn, and the Mw/Mn were measured by the gel permeation chromatography (GPC). As a GPC instrument, GPC, 150C ALC/GPC manufactured by Waters was used; as columns, one GPC UT802.5 GPC column and two GPC UT806M columns, both manufactured by SHODEX, were used; and a differential refractometer (RI detector) was used as a detector; to perform measurement. As a measurement solvent, o-dichlorobenzene was used and a column temperature was set to 145° C. A concentration of a sample was adjusted to 1.0 mg/ml, and 200 microliter of the sample solution was injected, to perform measurement. A molecular weight calibration curve was obtained, by a universal calibration method, by using a sample of a polystyrene the molecular weight of which was known.

(E) Gel Fraction.

A twilled dutch weave stainless steel filter of 1,000 mesh (pore size: 25 μm) manufactured by MIYAKE KINZOKU CO., LTD. was cut into a size of 180 mm×60 mm. Next, the filter was formed, by using a pen or the like, into a cylindrical shape having an inner diameter ranging from 15 mm to 20 mm, and a length of 100 mm, and one end portion of the filter was folded back by about 10 mm. A mass (W1) of the cylindrical filter was measured. After that, 5 g to 10 g of a fiber sample was put in the cylindrical filter. Next, the other end portion of the cylindrical filter was folded back by about 10 mm, to encapsulate the sample. A mass (W2) of the cylindrical filter containing the sample was measured.

The cylindrical filter containing the sample was put in a flask containing three boiling stones and 400 ml of xylene, and a solution in the flask was heated to about 250° C. to 260° C., to extract, from the filter, a non-gel portion of polyethylene, which had not gelled. A period for the extraction was nine hours. After the extraction, a product having gelled was taken out in a state where the product was contained in the stainless steel filter, and was vacuum-dried at 50° C. for 12 hours, and a mass of the resultant product, that is, a mass (W3) of the filter and the gel product which had been dried after the extraction was measured. A gel fraction was calculated, by using the mass (W1) of the filter only and the mass (W2) of the filter containing the above-described sample having not been subjected to the extraction, based on the following equation. Each mass was weighed to second decimal places in mg, and a numerical value of the obtained mass was rounded to one decimal place.

Gel fraction(ppm)=10⁶×(W3−W1)/(W2−W1)

(F) Zero Shear Viscosity.

In order to measure a viscosity, the fiber was cut into a sample having a size of about 1 cm, and the sample was press-formed into a formed product having a diameter of 25 mm and a thickness of 1 mm, with great care, so as to prevent the sample from containing foams. At this time, the condition for pressing was such that a pressing temperature was 160° C., a pressing pressure was 20 kg/cm², and a pressing time period was five minutes. A rheometer (ARES) manufactured by TA Instruments Japan was used as a viscosity measurement device. A measurement atmosphere was a nitrogen atmosphere, and a cone and plate jig having a diameter of 25 mm was used, and a measurement temperature was 190° C. The shear flow was dynamically measured, and an amount of strain was 5%. A measurement frequency was started with 100 rad/sec., and the measurement was performed up to 0.01 rad/sec. A waiting time period up to the start of the measurement after the sample was set on the jig was 15 minutes. A zero shear viscosity was calculated by using, as analysis software, Orchestrator-7 manufactured by TA Instruments Japan.

(G) Variation, Represented as CV(%), in Fineness Among Single Yarn.

A yarn was cut so as to be 1 m, and the yarn having been cut was separated to obtain 30 to 50 single yarns. A mass of each single yarn having been obtained through the separation was measured to obtain the CV(%) by using the following equation.

Variation CV(%) in fineness among single yarns=100×(single yarn fineness standard deviation)/(average of single yarn finenesses)

(H) Rate of Change of Thermal Conductivity.

A value (G₃₀₀) of the thermal conductivity obtained at 300K in the measurement of a thermal conductivity as described in (B), and a value (G₁₀₀) of the thermal conductivity obtained at 100K in the measurement of a thermal conductivity as described in (B) were used to calculate a rate of change of thermal conductivity based on the following equation.

Rate of change of thermal conductivity(W/mK·K)=(G₃₀₀−G₁₀₀)/200

(I) Unevenness U(%) of Fineness in Yarn Longitudinal Direction.

“Evenness Tester Model KET-80C” manufactured by KEISOKKI KOGYO CO., LTD. was used for Uster measurement. The measurement speed of a sample was 25 m/min., S-twist was performed by a twister, and the number of revolutions of the twister was 55× the speed of the sample, to perform the measurement for five minutes. The measurement signal was supplied to an integrator unit, thereby obtaining a Uster normal U(%).

### Example 1

To a high-density polyethylene having a weight average molecular weight of 100,000, and a ratio (Mw/Mn) of the weight average molecular weight to a number average molecular weight which was 2.6, 20 ppm of 2,5-dimethyl-2,5-di(t-butylperoxy)hexane was added as a crosslinking agent, and the mixture was kneaded by using a twin-screw extruder. The crosslinked polyethylene was extruded at 300° C., through a spinneret having 10 holes each having a diameter of 0.8 mm, at a speed of 0.6 g/min. which was a discharge amount of one hole. The extruded fiber was caused to pass through a hot tube which was heated to 270° C., and which had a length of 60 mm, and was then quenched by air maintained at 20° C., and was taken up at a speed of 90 m/min. to obtain an undrawn yarn. The undrawn yarn having been obtained was checked for a maximum drawing speed (a drawing speed at which a breaking occurs) at 100° C. and at a draw ratio of 15, and the maximum drawing speed was determined as 600 m/min. The undrawn yarn was heated to 100° C., and was drawn at a drawing speed of 300 m/min. and at a draw ratio of 18, to obtain a drawn yarn.

The obtained fiber was used as a sheath yarn, and a spandex having a fineness of 155 dtex (“Espa (registered trademark)” manufactured by TOYOBO CO., LTD.) was used as a core yarn, to obtain a single covering yarn. The obtained single covering yarn was used to knit gloves having a weight per unit area which was 500 g/m², by using a glove knitting machine manufactured by SHIMA SEIKI MFG., LTD. The index value of the coup tester is indicated in Table 1. The obtained gloves were excellent in ease of putting on and taking off.

### Example 2

An experiment was conducted in the same manner as in example 1 except that an amount of the crosslinking agent was changed as indicated in Table 1, and a draw ratio was 16, for obtaining a drawn yarn.

### Example 3

An experiment was conducted in the same manner as in example 1 except that an added amount of the crosslinking agent was 5 ppm, and the undrawn yarn was heated to 20° C., was fed at a speed of 10 m/min., was drawn at a draw ratio of two, was then heated to 100° C., and was drawn at a draw ratio of 16, to obtain a drawn yarn. The maximum drawing speed of the undrawn yarn, obtained in example 3, at 100° C. and at a draw ratio of 15 was 580 m/min.

### Comparative Example 1

A high-density polyethylene having a weight average molecular weight of 115,000, and a ratio (Mw/Mn) of the weight average molecular weight to a number average molecular weight which was 2.3 was extruded at 300° C., through a spinneret having 10 holes each having a diameter of 0.8 mm, at a speed of 0.6 g/min. which was a discharge amount of one hole. The extruded fiber was caused to pass through a hot tube which was heated to 270° C., and which had a length of 60 mm, and was then quenched by air maintained at 20° C., and was taken up at a speed of 90 m/min. to obtain an undrawn yarn. The undrawn yarn having been obtained was checked for a maximum drawing speed (a drawing speed at which a breaking occurs) at 100° C. and at a draw ratio of 15, and the maximum drawing speed was determined as 400 m/min. The undrawn yarn was heated to 20° C., was fed at a speed of 10 m/min., was drawn at a draw ratio of two, was then heated to 100° C., and was drawn at a draw ratio of 6 to obtain a drawn yarn. Physical property values of the obtained fiber are indicated in Table 1.

The obtained fiber was used as a sheath yarn, and a spandex having a fineness of 155 dtex (“Espa (registered trademark)” manufactured by TOYOBO CO., LTD.) was used as a core yarn, to obtain a single covering yarn. The obtained single covering yarn was used to knit gloves having a weight per unit area which was 500 g/m², by using a glove knitting machine manufactured by SHIMA SEIKI MFG., LTD. The index value of the coup tester is indicated in Table 1.

### Comparative Example 2

An experiment was conducted in the same manner as in comparative example 1 except that the undrawn yarn obtained in comparative example 1 was heated to 100° C. and was drawn at a draw ratio of 12 without performing cold-drawing (that is, without performing drawing at a temperature of 20° C., at a speed of 10 m/min., and at a draw ratio of two), to obtain a drawn yarn. The maximum drawing speed at a draw ratio of 15 was 350 m/min.

### Comparative Example 3

A slurry mixture obtained by dispersing 10 wt % of an ultrahigh molecular weight polyethylene having a weight average molecular weight of 3,200,000, and a ratio (Mw/Mn) of the weight average molecular weight to a number average molecular weight which was 6.3, in 90 wt % of decahydronaphthalene, and the slurry mixture being stirred was melted in a screw-type kneader which was set to 230° C., and was supplied, to a spinneret which was set to 170° C., had 2000 discharge holes each having a diameter of 0.2 mm, by using a metering pump, at a speed of 0.08 g/min. which was a discharge amount of one hole. A nitrogen gas which was adjusted to 100° C. was applied to a yarn, at a speed of 1.2 m/min., as uniformly as possible by using a slit-shaped gas supply orifice mounted immediately below a nozzle, to positively evaporate decahydronaphthalene on a surface of the fiber, and, immediately after that, the yarn was substantially cooled by air flow which was set to 30° C., and the yarn was taken up at a speed of 50 m/min. by using a Nelson roller disposed downstream of the nozzle. At this time, a solvent contained in the yarn was reduced such that the mass of the solvent was about half the original mass thereof. Subsequently, the obtained fiber was drawn, in an oven heated to 100° C., at a draw ratio of three, and subsequently the obtained fiber was drawn, in an oven heated to 149° C., at a draw ratio of 4.6. The maximum drawing speed at a draw ratio of 15 was 300 m/min. A uniform fiber was able to be obtained without causing breaking halfway. Physical property values of the obtained fiber are indicated in Table 1.

### Comparative Example 4

A polyethylene resin was obtained in the same manner as in example 1 except that an added amount of the crosslinking agent was 10,000 ppm. Spinning of the obtained polyethylene resin was attempted. However, increase of back pressure was too great to perform spinning. The gel fraction and the zero shear viscosity of the polyethylene resin obtained in comparative example 4 are indicated in Table 1.

TABLE 1

| | | | Example | Example | Example | Comparative | Comparative | Comparative | Comparative |
|---|---|---|---|---|---|---|---|---|---|
| | | | 1 | 2 | 3 | Example 1 | Example 2 | Example 3 | Example 4 |
| Step | Weight average molecular | — | 102,000 | 102,000 | 102,000 | 115,000 | 115,000 | 3,200,000 | 100,000 |
| | weight Mw | | | | | | | | |
| | Molecular weight | — | 2.6 | 2.6 | 2.5 | 2.3 | 2.3 | 3.8 | 3.2 |
| | distribution | | | | | | | | |
| | Mw/Mn | | | | | | | | |
| | Crosslinking agent | ppm | 20 | 22 | 5 | Not added | Not added | Not added | 10,000 |
| | Maximum drawing speed | m/min | 600 | 600 | 580 | 400 | 350 | 300 | — |
| | at a draw ratio of 15 | | | | | | | | |
| Fiber | Tensile strength | cN/dtex | 13 | 11 | 10 | 17 | 16 | 30 | — |
| Property | Modulus | cN/dtex | 637 | 585 | 559 | 788 | 699 | 1,011 | — |
| | Zero shear viscosity | Pa · s | 17,000 | 16,700 | 14,400 | 7,900 | 7,900 | Unmeasurable | 301,000 |
| | Thermal conductivity | [W · mK] | 30 | 25 | 34 | 41 | 38 | 69 | — |
| | | (@300K) | | | | | | | |
| | Rate of change of | W/mK · K | 15 | 13 | 10 | 5 | 4 | 38 | — |
| | thermal conductivity | | | | | | | | |
| | Variation CV(%) in | % | 2 | 1 | 2 | 4 | 4 | 7 | — |
| | fineness | | | | | | | | |
| | among single yarns | | | | | | | | |
| | U % | % | 4 | 2 | 2 | 7 | 6 | 5 | — |
| | Gel fraction | ppm | 2,000 | 2,500 | 480 | 41 | 60 | 95 | 760,000 |
| | Coup | | 8 | 8 | 8 | 7 | 7 | 4 | — |

### Example 4

An experiment was conducted in the same manner as in example 3 except that 55 ppm of dicumyl peroxide was added as a crosslinking agent to a high-density polyethylene having a weight average molecular weight of 90,000, and a ratio (Mw/Mn) of the weight average molecular weight to a number average molecular weight which was 2.5. The maximum drawing speed of an undrawn yarn obtained in example 4, at 100° C. and at a draw ratio of 15 was 590 m/min. Physical property values of the obtained fiber are indicated in Table 2.

### Example 5

An experiment was conducted in the same manner as in example 4 except that an added amount of the crosslinking agent was 205 ppm. The maximum drawing speed of an undrawn yarn obtained in example 5, at 100° C. and at a draw ratio of 15 was 600 m/min. Physical property values of the obtained fiber are indicated in Table 2.

### Example 6

An experiment was conducted in the same manner as in example 3 except that 280 ppm of t-butyl peroxy benzoate was added as a crosslinking agent to a high-density polyethylene having a weight average molecular weight of 110,000, and a ratio (Mw/Mn) of the weight average molecular weight to a number average molecular weight which was 2.5. The maximum drawing speed of an undrawn yarn obtained in example 6, at 100° C. and at a draw ratio of 15 was 590 m/min. Physical property values of the obtained fiber are indicated in Table 2.

### Example 7

An experiment was conducted in the same manner as in example 6 except that an added amount of the crosslinking agent was 560 ppm. The maximum drawing speed of an undrawn yarn obtained in example 7, at 100° C. and at a draw ratio of 15 was 600 m/min. Physical property values of the obtained fiber are indicated in Table 2.

### Example 8

An experiment was conducted in the same manner as in example 3 except that 320 ppm of t-butyl peroxy ketone was added as a crosslinking agent to a high-density polyethylene having a weight average molecular weight of 95,000, and a ratio (Mw/Mn) of the weight average molecular weight to a number average molecular weight which was 2.5. The maximum drawing speed of an undrawn yarn obtained in example 8, at 100° C. and at a draw ratio of 15 was 540 m/min. Physical property values of the obtained fiber are indicated in Table 2.

### Example 9

An experiment was conducted in the same manner as in example 9 except that an added amount of the crosslinking agent was 840 ppm. The maximum drawing speed of an undrawn yarn obtained in example 9, at 100° C. and at a draw ratio of 15 was 580 m/min. Physical property values of the obtained fiber are indicated in Table 2.

TABLE 2

| | | | Example | Example | Example | Example | Example | Example |
|---|---|---|---|---|---|---|---|---|
| | | | 4 | 5 | 6 | 7 | 8 | 9 |
| Step | Weight average molecular | — | 90,000 | 90,000 | 110,000 | 110,000 | 95,000 | 95,000 |
| | weight Mw | | | | | | | |
| | Molecular weight distribution | — | 2.5 | 2.5 | 2.5 | 2.5 | 2.5 | 2.5 |
| | Mw/Mn | | | | | | | |
| | Crosslinking agent | ppm | 55 | 205 | 280 | 560 | 320 | 840 |
| | Maximum drawing speed | m/min | 590 | 600 | 590 | 600 | 540 | 580 |
| | at a draw ratio of 15 | | | | | | | |
| Fiber | Tensile strength | cN/dtex | 15 | 11 | 12 | 13 | 14 | 13 |
| Property | Modulus | cN/dtex | 564 | 595 | 581 | 642 | 613 | 699 |
| | Zero shear viscosity | Pa · s | 31,900 | 90,300 | 98,800 | 200,500 | 216,000 | 263,000 |
| | Thermal conductivity | [W · mK] | 28 | 31 | 30 | 33 | 26 | 34 |
| | | (@300K) | | | | | | |
| | Rate of change of | W/mK · K | 14 | 15 | 12 | 14 | 13 | 14 |
| | thermal conductivity | | | | | | | |
| | Variation CV(%) in fineness | % | 2 | 2 | 2 | 2 | 3 | 3 |
| | among single yarns | | | | | | | |
| | U % | % | 3 | 2 | 2 | 2 | 2 | 2 |
| | Gel fraction | ppm | 2,800 | 4,220 | 5,510 | 6,530 | 5,990 | 8,920 |
| | Coup | | 8 | 8 | 8 | 8 | 8 | 8 |

### INDUSTRIAL APPLICABILITY

The highly functional polyethylene fiber of the present invention is excellent in heat-retaining property and abrasion resistance, is further excellent in productivity and subsequent process passability, is economical, and greatly contributes to industries.

1. A polyethylene fiber that is formed of a polyethylene which substantially contains ethylene as a repeating unit, and the polyethylene fiber has, when the polyethylene is in a fibrous state, a weight average molecular weight (Mw) ranging from 50,000 to 300,000, and has a ratio (Mw/Mn) of the weight average molecular weight to a number average molecular weight (Mn) which is less than or equal to 4.0, wherein a gel fraction of the fiber ranges from 100 ppm to 10,000 ppm.

2. A polyethylene fiber that is formed of a polyethylene which substantially contains ethylene as a repeating unit, and the polyethylene fiber has, when the polyethylene is in a fibrous state, a weight average molecular weight (Mw) ranging from 50,000 to 300,000, and has a ratio (Mw/Mn) of the weight average molecular weight to a number average molecular weight (Mn) which is less than or equal to 4.0, wherein a zero shear viscosity of the fiber in a molten state at 190° C. ranges from 8,000 (Pa·s) to 300,000 (Pa·s).

3. The polyethylene fiber according to claim 1, wherein a variation represented as a CV % in a fineness among single yarns is less than 5%.

4. The polyethylene fiber according to claim 1, wherein an unevenness U % of a fineness in a yarn longitudinal direction is less than 30%.

5. The polyethylene fiber according to claim 1, wherein a thermal conductivity at a measurement temperature of 300K in a fiber axis direction ranges from 6 W/mK to 50 W/mK.

6. The polyethylene fiber according to claim 1 wherein a rate of change of the thermal conductivity in the fiber axis direction is greater than or equal to 6 W/mK·K when a measurement temperature is varied from 100K to 300K.

7-9. (canceled)

10. The polyethylene fiber according to claim 2, wherein a variation represented as a CV % in a fineness among single yarns is less than 5%.

11. The polyethylene fiber according to 2, wherein an unevenness U % of a fineness in a yarn longitudinal direction is less than 30%.

12. The polyethylene fiber according to 2, wherein a thermal conductivity at a measurement temperature of 300K in a fiber axis direction ranges from 6 W/mK to 50 W/mK.

13. The polyethylene fiber according to 2, wherein a rate of change of the thermal conductivity in the fiber axis direction is greater than or equal to 6 W/mK·K when a measurement temperature is varied from 100K to 300K.

14. A covered elastic yarn comprising:
an elastic fiber; and
an polyethylene fiber as defined in claim 1 covering the elastic fiber.

15. A protective textile comprising a polyethylene fiber as defined in claim 1, wherein the protective textile has an index value, as measured by a coup tester, greater than or equal to 6.

16. A cut resistant glove comprising a protective textile as defined in claim 15.
